(19) United States
(12) Patent Application Publication
(10) Pub. No.: US 2018/0278852 A1
(43) Pub. Date: Sep. 27, 2018

(54) OBJECT TRACKING SYSTEM AND METHOD

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: CHENG-LONG LIN, New Taipei (TW)

(21) Appl. No.: 15/468,134

(22) Filed: Mar. 24, 2017

(51) Int. Cl. H04N 5/232; H04N 7/18; G06T 7/20; G06K 9/62; G06K 9/00

(52) U.S. Cl. CPC H04N 5/23296; H04N 7/183; H04N 7/188; G06T 2207/30232; G06K 9/6267; G06K 9/623; G06K 9/00771; G06T 7/20

(57) ABSTRACT

In a system and method for tracking objects, a monitoring device includes multiple sensing units and an image acquisition unit, the multiple sensing units matching with multiple subareas one to one. Sensed events uploaded by the multiple sensing units are received. The image acquisition unit is controlled to collect images of objects in one or multiple subareas according to predetermined rules of image capturing sensed event.

### FIELD

The subject matter herein generally relates to mobile terminals, in particular to objects tracking.

### BACKGROUND

An object tracking system based on a monitoring device may be limited in tracking visible objects. When an object moves out of an initial monitoring range of the monitoring device, images of the object cannot be captured. Tracking multiple objects based on the monitoring device may be unavailable under specific conditions.

### BRIEF DESCRIPTION OF THE DRAWINGS

Implementations of the present technology will now be described, by way of example only, with reference to the attached figures, wherein:

FIG. 1 is a block diagram of an exemplary embodiment of a monitoring device.

FIG. 2 is a block diagram of an exemplary embodiment of functional modules of an object tracking system of the monitoring device of FIG. 1.

FIG. 3A illustrates an exemplary embodiment to set camera directions of the monitoring device of FIG. 1.

FIG. 3B illustrates an exemplary embodiment of capturing and monitoring processes for objects residing in multiple sensing subareas of the object tracking system of FIG. 2.

FIG. 4 illustrates a flowchart of an embodiment of an object tracking method.

FIG. 5 is a flowchart of an embodiment of a method for collecting image of the objects residing in the multiple sensing subareas matched with multiple sensed events.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one”.

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

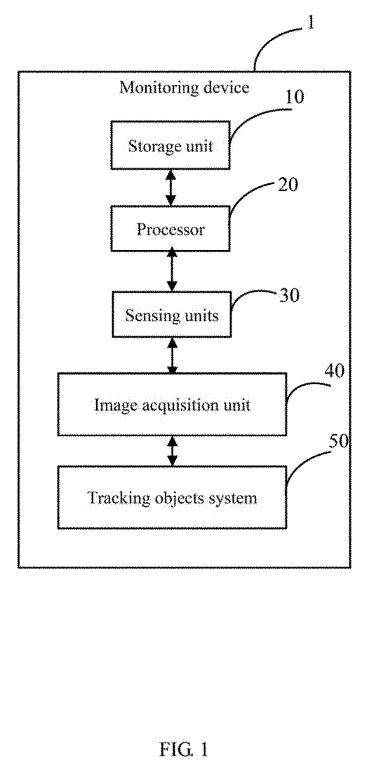

FIG. 1 illustrates a block diagram of an embodiment of a monitoring device 1. In the embodiment, the monitoring device 1 includes a storage unit 10, a processor 20, multiple sensing units 30, at least one image acquisition unit 40, and an object tracking system 50. The image acquisition unit 50 can pan horizontally and vertically to change object capturing direction. The multiple sensing units 30 sense objects within a fixed area. A range of the fixed area is determined by hardware properties of the multiple sensing units 30. The fixed area can be equally divided into multiple subareas. The multiple sensing units 30 are one-to-one matching with the multiple subareas. Each sensing unit 30 is configured to sense objects within a subarea and record a sensed event. The sensed event is uploaded to the processor 20 and stored in the storage unit 10. The processor 20 controls the image acquisition unit 40 to pan to collect image of a single or multiple subareas according to the sensed events uploaded by the multiple sensing units 30.

In the embodiment, the multiple sensing units 30 may be position sensors, Radio Freqency (RF) sensors, Passive Infrared Radiation (PIR) sensors, or other. The multiple sensing units 30 determine if there are objects within the fixed area. A type and quantity of the sensing units 30 is determined by users according to actual demand. In the embodiment, the image acquisition unit 40 can be a camera or other device with video capabilities.

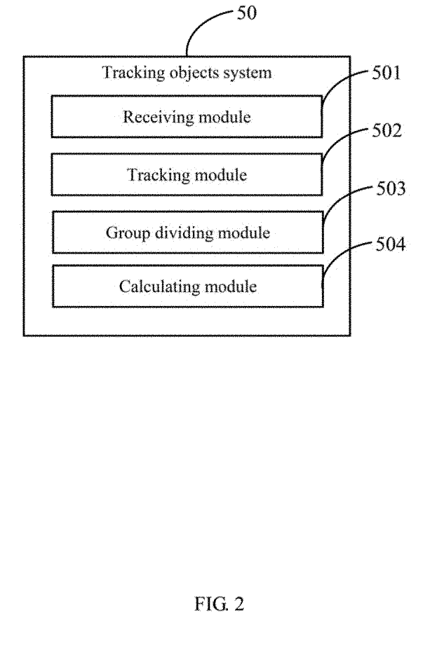

FIG. 2 illustrates a block diagram of an exemplary embodiment of functional modules of an object tracking system 50. The object tracking system 50 includes a receiving module 501, a tracking module 502, a group dividing module 503, and a calculating module 504. The one or more function modules can include computerized code in the form of one or more programs that are stored in the storage unit 10, and executed by the processor 20 to provide functions of the object tracking system 50. Descriptions of the functions of the modules 501-504 are given with reference to FIG. 2.

The receiving module 501 receives one or multiple sensed events uploaded by the multiple sensing units 30. In the embodiment, when one of the multiple sensing units 30 senses objects within the corresponding subarea, a sensed event is defined and uploaded to the processor 20. The sensed event can be an initial data related to the objects. The initial data comprises a quantity of the objects.

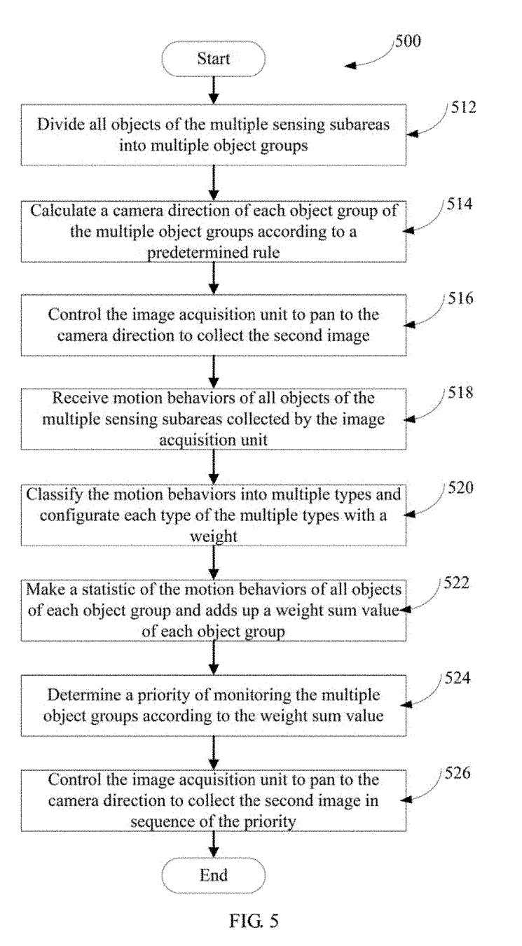

The tracking module 502 controls the image acquisition unit 40 to collect images of objects in one or multiple subareas, wherein the one or multiple sensed events occur correspondingly in the one or multiple subareas. For example, when the receiving module 501 just receives one sensed event uploaded by a single sensing unit 30 (such as 30A, not shown in FIG. 1˜FIG. 5), the tracking module 502 controls the image acquisition unit 40 to collect first image of objects in the subareas corresponding to the single sensing unit 30 (such as 30A, not shown in FIG. 1˜FIG. 5). When the receiving module 501 receives multiple sensed events uploaded by multiple sensing units 30, the tracking module 502 records multiple sensing subareas corresponding to the multiple sensed events and the multiple sensing units corresponding to the multiple sensing subareas. The tracking module 502 controls the image acquisition unit 40 to collect second image of all objects of the multiple sensing subareas corresponding to the multiple sensed events.

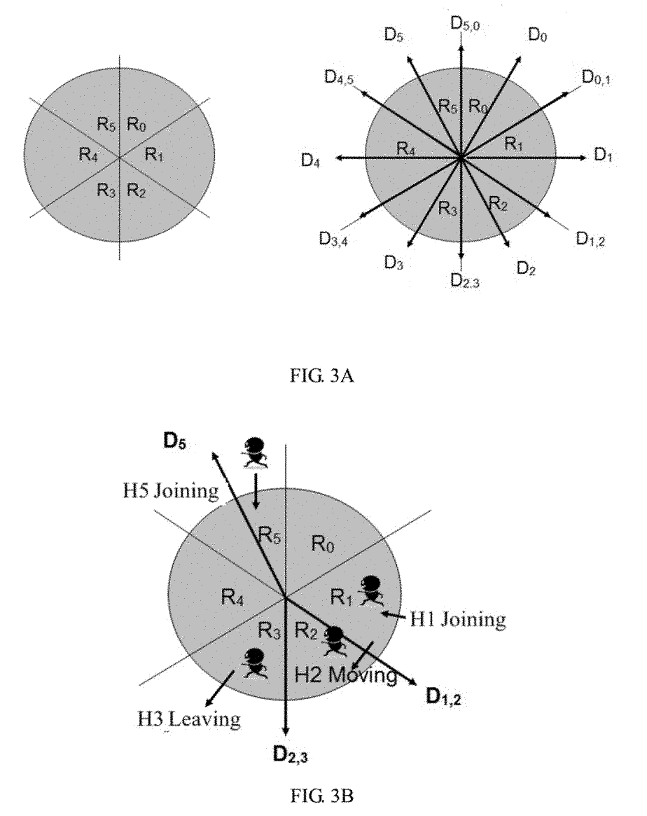

FIG. 3A illustrates an exemplary embodiment to set camera directions of the monitoring device 1. Referring to FIG. 3A, the monitoring device 1 has a uniform distribution of 6 PIR sensors around the device 1. In the embodiment, each PIR sensor senses within a subarea with the shape of sector. The angle of the sector is 60° at the center of the circle. In the embodiment, PIR sensors P₀˜P₅ are one-to-one corresponding to subareas R₀˜R₅. Sensor P₀ defines sensed events when sensing one or more objects in the subarea R₀, sensor P₁ senses sensed events happening in subarea R₁, and so on. When the sensed events occur, a motion of each object of the sensed events will be recorded. The motion behavior can include four types, Joining, Leaving, Moving, and Detecting. FIG. 3B illustrates the motion behavior.

Taking one subarea as an example, when sensor P₀ senses one or multiple objects in subarea R₀, sensed event A₀ is uploaded to the receiving module 501. The tracking module 502 controls the image acquisition unit 40 to pan to collect image of objects in the subarea R₀. Furthermore, the tracking module 502 collects one or multiple objects of the sensed event A₀ and regards the one or multiple objects as a target for tracking. The tracking module 502 controls the image acquisition unit 40 to pan with the moving of the one or multiple objects.

Taking objects in multiple subareas as an example, sensor P₀ senses one or multiple objects in subarea R₀, sensed event A₀ (A₀ only represents a predefined sensing signal) is defined. Sensor P₂ senses one or multiple objects in subarea R₂, sensed event A₂ is defined. Sensor P₃ senses one or multiple objects in subarea R₃, sensed event A₃ is defined. Sensed events A₀, A₂ and A₃ are uploaded to the receiving module 501. In case of sensed events A₀, A₂ and A₃, the tracking module 502 selects a subarea (such as R₂) from subareas R₀, R₂, R₃ according to a predetermined rule and controls the image acquisition unit 40 to pan to collect image of objects in the subarea R₂. The predetermined rule is described below.

In an embodiment, when objects occur in multiple subareas, the group dividing module 503 divides the multiple subareas and corresponding objects in the multiple subareas into multiple object groups according to the predetermined rule. The predetermined rule is related to quantity of the multiple subareas, range of angle (such as) 60° of each subarea, viewing angle (such as 120°) of the image acquisition unit 40, and the sensed events (such as A₀, A₂, A₃). Each object group of the object groups includes subarea or multiple neighboring subareas. For example, R₀ and R₁ can form the object group [R₀,R₁], R₂ and R₃ can form the object group [R₂,R₃], and R₄ and R₅ can form the object group [R₄,R₅].

In the embodiment, the viewing angle of the image acquisition unit 40 is 120°, so the image acquisition unit 40 can not collect images of objects in the subareas R₀, R₂ and R₃ at the same time. R₀, R₂ and R₃ can form the object group [R₀] and the object group [R₂,R₃] according to the second predetermined rule. The image acquisition unit 40 can collect image of only one object group from the object group [R₀] and the object group [R₂,R₃] at one time. So, when the tracking module 502 selects the object group [R₀], then the image acquisition unit 40 collects image of objects of the object group [R₀]. Otherwise, when the tracking module 502 selects the object groups [R₂,R₃], then the image acquisition unit 40 collects image of objects of the object groups [R₂,R₃]. In order to ensure that objects of the object groups [R₂,R₃] are collected within the viewing range of the image acquisition unit 40, the image acquisition unit 40 is controlled to pan to a camera direction [D_{2,3}].

In the embodiment, the image acquisition unit 40 can be set for 2N gathering directions according to the quantity value N of the sensing units 30. For example, referring to FIG. 3A, the monitoring device 1 has 6 of the sensing units 30, accordingly, the image acquisition unit 40 is set for 12 camera directions [D₀], [D_{0,1}], [D₁], [D_{1,2}], [D₂], [D_{2,3}], [D₃], [D_{3,4}], [D₄], [D_{4,5}], [D₅] and [D_{5,0}].

The calculating module 504 classifies the motion behaviors of objects into multiple types and configures each type of the multiple types with a weight. In the embodiment, the motion behavior of each object of the sensed events is recorded. The motion behaviors include four types, Joining, Leaving, Moving and Detecting. Each type of the motion behavior is given different weight. For example, the weight values of Joining, Leaving, Moving and Detecting are respectively 4 points, 1 point, 3 points, and 2 points. The image acquisition unit 40 detects the motion behaviors determining by location changes of detected objects within a predetermined time. For example, the predetermined time can be a time interval between T and T+1. The predetermined time is configured depending on area size of the subarea.

The calculating module 504 makes a statistic of the motion behaviors of all objects of each object group and adds up a weight sum value of each object group. A priority of monitoring the multiple object groups according to the weight sum value is determined. The calculating module 504 controls the image acquisition unit 40 to pan to the camera direction to collect the images in order of the priority. In the embodiment, object group can be called OG and the camera direction can be called CD for short. That is, the priority of CD is based on importance of each OG The predetermined rule is as follows:

(1) when subarea Rᵢ has a sensed event, but neither subarea Rᵢ₋₁ nor subarea R₁₊₁ has sensed event, OG is [Rᵢ], CD is correspondingly [Dᵢ].

(2) when subareas Rᵢ and Rᵢ₊₁ have sensed event, but neither subarea Rᵢ₊₁ nor subarea Rᵢ₊₂ has sensed event, OG is [Rᵢ,Rᵢ₊₁], CD is correspondingly [D_{i,i+1}].

(3) when subareas Rᵢ, Rᵢ₊₁ and Rᵢ₊₂ have sensed event, but neither subarea Rᵢ₋₁ nor subarea Rᵢ₊₃ has sensed event, OGs are [Rᵢ,Rᵢ₊₁] and [Rᵢ₊₁,Rᵢ₊₂], CDs are correspondingly [D_{i,i+1}] and [D_{i+1,i+2}].

(4) when subareas Rᵢ, Rᵢ₊₁, Rᵢ₊₂ and Rᵢ₊₃ have sensed event, but neither subarea Rᵢ₋₁ nor subarea Rᵢ₊₄ occurs sensed event, OGs are [Rᵢ,Rᵢ₊₁] and [Rᵢ₊₂,Rᵢ₊₃], CDs are correspondingly [D_{i,i+1}] and [D_{i+2,i+3}].

(5) when subareas Rᵢ, Rᵢ₊₁, Rᵢ₊₂, Rᵢ₊₃ and Rᵢ₊₄ have sensed event, but subarea Rᵢ₊₅ does not have sensed event, OGs are [Rᵢ,Rᵢ₊₁], MaxPriority{[Rᵢ₊₁,Rᵢ₊₂] or [Rᵢ₊₂] or [Rᵢ₊₂,Rᵢ₊₃]} and [Rᵢ₊₃,Rᵢ₊₄], and CDs are correspondingly [D_{i,i+1}], {[D_{i+1,i+2}] or [Dᵢ₊₂] or [R_{i+2,i+3}]}, [D_{i+4,i+5}]. MaxPriority{[Rᵢ₊₁,Rᵢ₊₂] or [Rᵢ₊₂] or [Rᵢ₊₂,Rᵢ₊₃]} means selecting maximum quantity of objects of three object groups of [R₁₊₁,R₁₊₂], [R₁₊₂] and [R₁₊₂,R₁₊₃]. The CDs {[D_{i+1,i+2}] or [Dᵢ₊₂] or [D_{i+2,i+3}]} means selecting camera direction corresponding to the MaxPriority{[Rᵢ₊₁,Rᵢ₊₂] or [Rᵢ₊₂] or [Rᵢ₊₂,Rᵢ₊₃]} after OG is selected.

(6) when all subareas Rᵢ˜Rᵢ₊₅ have sensed event, OGs are [Rᵢ,Rᵢ₊₁], [Rᵢ₊₂,Rᵢ₊₃], and [Rᵢ₊₄,Rᵢ₊₅], and CDs are correspondingly [D_{i,i+1}], [D_{i+2,i+3}] and [D_{i+4,i+5}].

(7) when quantity value of CDs is large than 2, referring to corresponding multiple OGs, the calculating module 504 makes a statistic of the motion behaviors of all objects of the corresponding multiple OGs and adds up a weight sum value of each OG of the corresponding multiple OGs. A priority of monitoring the corresponding multiple OGs according to the weight sum value is determined. The calculating module 504 controls the image acquisition unit 40 to pan to corresponding CDs to collect the images in order of the priority.

FIG. 3B illustrates an exemplary embodiment to capture and monitor processes for objects within multiple sensed subareas. Referring to FIG. 3B, PIR sensors P₀˜P₅ are one-to-one corresponding to subareas R₀˜R₅, each subarea of subareas R₀˜R₅ has the same segment sector. The angle of the sector is 60°. In the embodiment, 4 objects, H₁, H₂, H₃ and H₅, are respectively in subareas R₁, R₂, R₃, and R₅. Subareas R₁, R₂, R₃ meet (4) of the predetermined rules defined above. So subareas R₁, R₂, R₃ can be divided into object groups [R₁,R₂] and [R₂,R₃], that is, OGs are [R₁,R₂] and [R₂,R₃]. CDs are [D_{1,2}] and [D_{2,3}]. For subarea R₅, subarea R₅ meets (1) of the predetermined rules defined above, so OG is [R₅], CD is [D₅].

In the embodiment, the statuses of all objects uploaded by sensing units 30 are recorded in a status information table. The status information table is updated in the predetermined time (such as the time interval between T and T+1). The calculating module 504 calculates the motion behavior of each object. In the embodiment, the motion behavior of a object (to describe more clearly, the object is named A) is defined below:

When A is in a subarea at a point in time, the motion behavior is Detecting.

When A is in a subarea in time T, and is in another subarea of the subareas R₀˜R₅ in time T+1, the motion behavior is Moving.

When A is not in any subarea of the subareas R₀˜R₅ in time T, but is in one subarea of the subareas R₀˜R₅ in time T+1, the motion behavior is Joining.

When A is in one subarea of the subareas R₀˜R₅ in time T, but is not in any subarea of the subareas R₀˜R₅ in time T+1, the motion behavior is Leaving.

Referring to FIG. 3B, setting the predetermined time be 30s, the image acquisition unit 40 compares changes in status of objects H₁, H₂, H₃ and H₅ in 30s. The calculating module 504 calculates the motion behavior of objects H₁, H₂, H₃ and H₅ as corresponding to Joining, Moving, Leaving, and Joining. The image acquisition unit 40 calculates the weight value of H₁, H₂, H₃ and H₅ to corresponding to 4 points, 3 points, 1 point, and 4 points.

The calculating module 504 adds up weight sum value of object groups [R₅], [R₁,R₂] and [R₂,R₃] and determines a priority of monitoring the OGs [R₅], [R₁,R₂] and [R₂,R₃] according to the weight sum value. When the weight sum value of two or multiple object groups is the same, the object group which includes more objects has a priority in being monitored. In the embodiment, the weight sum value OG [R₅] adds up to 4 points, the weight sum value OG [R₁,R₂] adds up to 4+3=7 (points), the weight sum value OG [R₂,R₃] adds up to 3+1=4 (points). In the embodiment, the weight sum value OG [R₂,R₃] is equal to the weight sum value OG [R₅], but OG [R₂,R₃] includes 2 objects and OG [R₅] only includes 1 object. Therefore, OGs [R₂,R₃] have priority in being monitored. OGs [R₅], [R₁,R₂] and [R₂,R₃] are monitored in sequence of [R₁,R₂], [R₂,R₃] and [R₅] in turn. The image acquisition unit 40 is controlled to pan to the camera directions [D_{1,2}], [D_{2,3}], [D₅] to collect the images of [R₁,R₂], [R₂,R₃] and [R₅] in order of the priority.

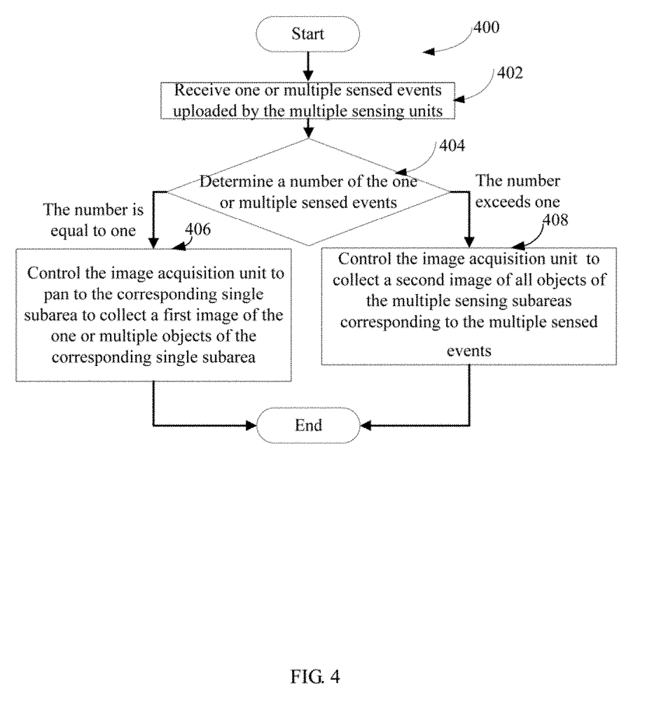

Referring to FIG. 4, a flowchart is presented in accordance with an embodiment of a method 400 for tracking objects, and the function modules 301-304, as FIG. 2 illustrates, are executed by the processor 10. The method 400 is provided by way of example.

At block 402, one or multiple sensed events uploaded by the multiple sensing units 30 are received.

At block 404, a number of sensed events uploaded by the multiple sensing units 30 is determined.

At block 406, when the number is equal to one, a corresponding single subarea corresponding to the sensed event is recorded, one or multiple objects of the one sensed event are collected and the one or multiple objects are regarded as tracking targets. The image acquisition unit 40 is controlled to pan to the corresponding single subarea to collect first image of the one or multiple objects of the corresponding single subarea.

At block 408, when the number exceeds one, multiple sensing subareas corresponding to the multiple sensed events and the multiple sensing units 30 matched with the multiple sensing subareas are recorded. The image acquisition unit 40 is controlled to collect second image of all objects of the multiple sensing subareas corresponding to the multiple sensed events.

Referring to FIG. 5, a flowchart is presented in accordance with an embodiment of a method 500 for collecting image of the objects residing in the multiple sensing subareas matched with multiple sensed events, and the function modules 501-504 as FIG. 2 illustrates are executed by the processor 10. Each block shown in FIG. 5 represents one or more processes, methods, or subroutines, carried out in the exemplary method 500. Additionally, the illustrated order of blocks is by example only and the order of the blocks can be changed. The method 500 can begin at block 512.

At block 512, the objects of the multiple sensing subareas are divided into multiple object groups.

At block 514, a camera direction of each object group of the multiple object groups is calculated according to a predetermined rule.

At block 516, the image acquisition unit 40 is controlled to pan to the camera direction to collect the second image.

At block 518, motion behaviors of all objects of the multiple sensing subareas collected by the image acquisition unit 40 are received.

At block 520, the motion behaviors are classified into multiple types and configures each of the multiple types with a weight.

At block 522, a statistic of the motion behaviors of the objects of each object group is made and a weight sum value of each object group is added up.

At block 524, a priority of monitoring the multiple object groups is determined according to the weight sum value.

At block 526, the image acquisition unit 40 is controlled to pan to the camera directions to collect the second image in sequence of the priority.

The embodiments shown and described above are only examples. Many details are often found in the art such as the other features of a device and method for tracking objects. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for tracking objects, executed in a monitoring device comprising multiple sensing units and an image acquisition unit, wherein the multiple sensing units are one-to-one matched with multiple subareas, the method comprising:
receiving one or multiple sensed events uploaded by the multiple sensing units; and
controlling the image acquisition unit to collect image of objects in one or multiple subareas, when the one or multiple sensed events are sensed correspondingly in the one or multiple subareas.

2. The method as claimed in claim 1, further comprising:
when a number of sensed events uploaded by the multiple sensing units is equal to one,
recording a corresponding single subarea corresponding to the uploaded sensed event;
collecting one or multiple objects of the one sensed event and configuring the one or multiple objects as tracking targets; and
panning the image acquisition unit to collect a first image of the one or multiple objects of the corresponding single subarea.

3. The method as claimed in claim 1, further comprising:
when a number of sensed events uploaded by the multiple sensing units exceeds one,
recording multiple sensing subareas corresponding to the multiple sensed events and the multiple sensing units corresponding to the multiple sensing subareas; and
controlling the image acquisition unit to collect a second image of objects of the multiple sensing subareas corresponding to the multiple sensed events.

4. The method as claimed in claim 3, further comprising:
dividing the objects of the multiple sensing subareas into multiple object groups;
calculating camera directions of the multiple object groups according to a predetermined rule; and
controlling the image acquisition unit to pan to the camera directions to collect the second image.

5. The method as claimed in claim 4, further comprising:
receiving motion behaviors of the objects of the multiple sensing subareas collected by the image acquisition unit;
classifying the motion behaviors into multiple types and configurating each of the multiple types with a weight;
making a statistic of the motion behaviors of all objects of each object group and adding up a weight sum value of each object group; and
determining a priority of monitoring the multiple object groups according to the weight sum value; and
controlling the image acquisition unit to pan to the camera direction to collect the second image in sequence of the priority.

6. A system for tracking objects, executed in a monitoring device comprising multiple sensing units and an image acquisition unit, wherein the multiple sensing units are one-to-one matched with multiple subareas, the system comprising:
at least one processor;
a storage unit; and
one or more programs that are stored in the storage unit and executed by the at least one processor, the one or more programs comprising instructions for:
receiving one or multiple sensed events uploaded by the multiple sensing units; and
controlling the image acquisition unit to collect image of objects in one or multiple subareas, when the one or multiple sensed events occur correspondingly in the one or multiple subareas.

7. The system as claimed in claim 6, wherein the one or more programs further comprise instructions for:
when a number of sensed events uploaded by the multiple sensing units is equal to one,
recording a corresponding single subarea corresponding to the uploaded sensed event when the number is equal to one;
collecting one or multiple objects of the one sensed event and configuring the one or multiple objects as tracking targets; and
panning the image acquisition unit to collect a first image of the one or multiple objects of the corresponding single subarea.

8. The system as claimed in claim 6, wherein the one or more programs further comprise instructions for:
when a number of sensed events uploaded by the multiple sensing units exceeds one,
recording multiple sensing subareas corresponding to the multiple sensed events and the multiple sensing units corresponding to the multiple sensing subareas; and
controlling the image acquisition unit to collect a second image of objects of the multiple sensing subareas corresponding to the multiple sensed events.

9. The system as claimed in claim 8, wherein the one or more programs further comprise instructions for:
dividing the objects of the multiple sensing subareas into multiple object groups;
calculating camera directions of the multiple object groups according to a predetermined rule; and
panning the image acquisition unit to the camera directions to collect the second image.

10. The system as claimed in claim 9, wherein the one or more programs further comprise instructions for:
receiving motion behaviors of the objects of the multiple sensing subareas collected by the image acquisition unit;
classifying the motion behaviors into multiple types and configurating each of the multiple types with a weight;
making a statistic of the motion behaviors of the objects of each object group and adding up a weight sum value of each object group; and
determining a priority of monitoring the multiple object groups according to the weight sum value; and
controlling the image acquisition unit to pan to the camera directions to collect the second image in sequence of the priority.
